(19) United States
(12) Patent Application Publication
(10) Pub. No.: US 2025/0116385 A1
(43) Pub. Date: Apr. 10, 2025

(54) ADVANCE NOTICE SYSTEM AND ELECTRIC VEHICLE

(71) Applicant: IHI Corporation, Tokyo (JP)

(72) Inventors: Motonao NIIZUMA, Tokyo (JP); Kenji NISHIMURA, Tokyo (JP)

(73) Assignee: IHI Corporation, Tokyo (JP)

(21) Appl. No.: 18/901,147

(22) Filed: Sep. 30, 2024

(30) Foreign Application Priority Data
Oct. 5, 2023 (JP) 2023-173418

(51) Int. Cl. F21S 41/60; B60Q 1/50

(52) U.S. Cl. CPC F21S 41/60; B60Q 1/50; B60Q 2400/50

(57) ABSTRACT

An advance notice system according to one aspect of the present disclosure gives, in a charging area where power feeding is performed from a power feeding apparatus to a vehicle, an advance notice of availability of the charging area. An advance notice system includes a projection device configured to project a predetermined pattern on a projection surface that is a surface close to the charging area in response to an instruction, and a vehicle control device including a preparation detection unit configured to detect a preparatory operation that is an operation performed before a vehicle leaves the charging area, and an instruction unit configured to give a start instruction to the projection device to start projection of the predetermined pattern in response to detection of the preparatory operation.

### CROSS-REFERENCE TO RELATED APPLICATIONS

This application claims the benefit of priority from Japanese Patent Application No. 2023-173418, filed on Oct. 5, 2023, the entire contents of which are incorporated herein by reference.

### TECHNICAL FIELD

The present disclosure relates to an advance notice system and an electric vehicle.

### BACKGROUND OF THE INVENTION

The electric vehicle is charged using, for example, a charging facility provided in a parking lot. Japanese Unexamined Patent Publication No. 2015-116010 describes a technique for reserving a charging facility. In the technique described in Japanese Unexamined Patent Publication No. 2015-116010, when charging is completed, notification information for prompting movement is transmitted to a terminal of a user of the vehicle on which charging is completed, and use guidance information of the charging facility is transmitted to a terminal of a user of a vehicle waiting for reservation.

### SUMMARY OF THE INVENTION

It is unclear from the viewpoint of other electric vehicles whether the electric vehicle using the charging facility is about to leave. Other electric vehicles had to look for an available charging facility. The present disclosure describes that a technique capable of improving an occupancy rate and convenience regarding a charging area is provided.

An advance notice system according to one aspect of the present disclosure gives, in a charging area where power feeding is performed from a power feeding apparatus to a vehicle, an advance notice of availability of the charging area. An advance notice system includes a projection device configured to project a predetermined pattern on a projection surface that is a surface close to the charging area in response to an instruction, and a vehicle control device including a preparation detection unit configured to detect a preparatory operation that is an operation performed before a vehicle leaves the charging area, and an instruction unit configured to give a start instruction to the projection device in response to detection of the preparatory operation, the start instruction being an instruction to start projection of the predetermined pattern.

According to the present disclosure, it is possible to provide a technique capable of improving an occupancy rate and convenience regarding a charging area.

### BRIEF DESCRIPTION OF THE DRAWINGS

FIG. 1A is a side view schematically illustrating an example of charging of an electric vehicle; FIG. 1B is a plan view schematically illustrating the example of charging of the electric vehicle;

FIG. 2A is a side view schematically illustrating a configuration related to a power feeding apparatus of a wireless power transfer type; FIG. 2B is a plan view schematically illustrating the configuration related to the power feeding apparatus of the wireless power transfer type;

FIG. 3 is a block diagram illustrating an example of the entire configuration including the advance notice system;

FIG. 4 is a flowchart illustrating an example of an operation of the advance notice system;

FIG. 5A is a side view schematically illustrating a configuration including another example of a projection surface; FIG. 5B is a plan view schematically illustrating a configuration related to a projection surface according to a modification;

FIG. 6A is a side view illustrating an outline of an advance notice system according to a modification; FIG. 6B is a plan view illustrating the outline of the advance notice system according to the modification;

FIG. 7A is a side view schematically illustrating a configuration related to an advance notice system according to another modification; FIG. 7B is a plan view schematically illustrating the configuration related to the advance notice system according to the another modification;

FIG. 8A is a side view schematically illustrating an advance notice system according to still another modification; FIG. 8B is a plan view schematically illustrating the advance notice system according to the still another modification; and

FIG. 9 is a diagram schematically illustrating an advance notice system according to yet another modification.

### DETAILED DESCRIPTION

An advance notice system according to one aspect of the present disclosure gives, in a charging area where power feeding is performed from a power feeding apparatus to a vehicle, an advance notice of availability of the charging area. An advance notice system includes a projection device configured to project a predetermined pattern on a projection surface that is a surface close to the charging area in response to an instruction, and a vehicle control device including a preparation detection unit configured to detect a preparatory operation that is an operation performed before a vehicle leaves the charging area, and an instruction unit configured to give a start instruction to the projection device in response to detection of the preparatory operation, the start instruction being an instruction to start projection of the predetermined pattern.

In the advance notice system of the present disclosure, projection of the predetermined pattern on the projection surface is started in response to detection of the preparatory operation performed before a vehicle leaves the charging area. In other words, by projecting the predetermined pattern on the projection surface, an advance notice of availability of the charging area is given. For example, when seen from another electric vehicle passing around the charging area, the predetermined pattern can be recognized. A driver or the like of another electric vehicle can recognize that the charging area will be available soon by recognizing the predetermined pattern. Therefore, the driver or the like of another electric vehicle only needs to wait until the charging area becomes available, and does not need to look for another charging area. That is, another electric vehicle can immediately start charging using the power feeding apparatus. As a result, the occupancy rate of the charging area is improved, and convenience for drivers or the like of other electric vehicles using the charging area is improved.

The advance notice system may include a change detection unit configured to detect a change in a state immediately before a vehicle leaves the charging area. The instruction unit may give a stop instruction to the projection device in response to detection of the change, the stop instruction being an instruction to stop the projection of the predetermined pattern. In this case, the projection of the predetermined pattern is stopped immediately before the vehicle leaves the charging area. Accordingly, power consumption for projection can be suppressed. In addition, when the projection of the predetermined pattern is stopped, the projection device can be brought into a state capable of projecting another pattern. For example, the projection device can be used for projecting a pattern indicating an advance notice of a moving direction or the like.

The advance notice system may include a detection device configured to detect a vehicle around the charging area. The instruction unit may give the start instruction to the projection device further on the basis of detection of the vehicle. For example, when a vehicle is detected around the charging area, projection of the predetermined pattern is started. When the vehicle is not detected around the charging area, projection of the predetermined pattern is not started. Accordingly, power consumption for projection can be suppressed.

The advance notice system may include a detection device configured to capture an image around the charging area. The instruction unit may give an adjustment instruction to the projection device, the adjustment instruction being an instruction to adjust the luminance of a predetermined pattern on the basis of the brightness of the image acquired by the detection device. By increasing the luminance value of the predetermined pattern, visibility of the predetermined pattern can be improved. By decreasing the luminance value of the predetermined pattern, the power consumption for projection can be suppressed.

The advance notice system may include a detection device installed on a ground side and configured to capture the predetermined pattern projected on the projection surface, and a projection device installed on the ground side and configured to further project the predetermined pattern on another position of the projection surface by using the predetermined pattern captured by the detection device installed on the ground side.

An electric vehicle according to one aspect of the present disclosure includes the above-described advance notice system. By the electric vehicle, the occupancy rate of the charging area is improved, and the convenience for drivers or the like of other electric vehicles using the charging area is improved.

Hereinafter, embodiments of the present disclosure will be described with reference to the drawings. In the description of the drawings, the same elements will be given the same reference numerals, and redundant description will be omitted.

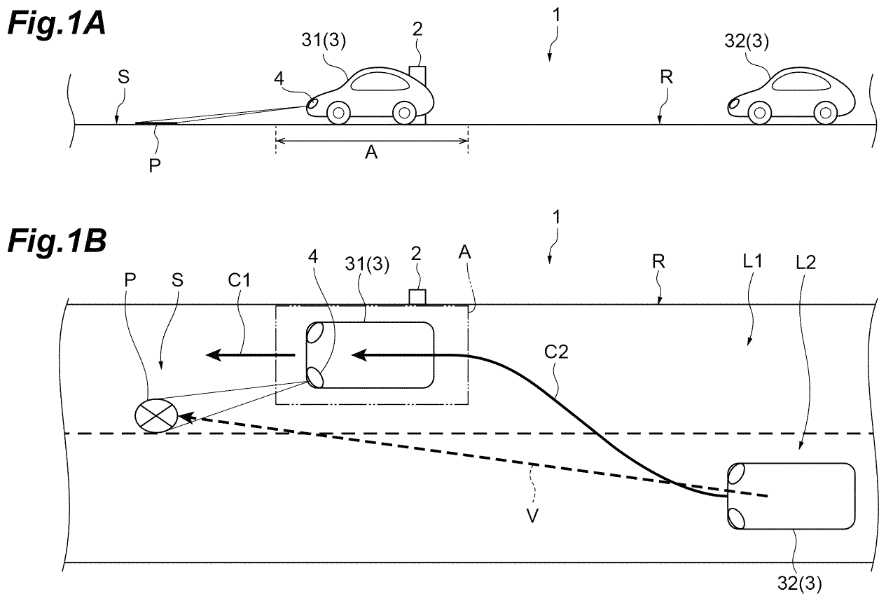

FIG. 1A is a side view schematically illustrating an example of charging of an electric vehicle 3. FIG. 1B is a plan view schematically illustrating an example of charging of the electric vehicle 3. FIGS. 1A and 1B illustrate a road surface R on which a vehicle such as the electric vehicle 3 can pass. The road surface R includes a parking lane L1 which is a lane for parking and a traveling lane L2 which is a lane for traveling. A charging area A is provided in the parking lane L1 of the road surface R.

The charging area A is an area where power feeding is performed from the power feeding apparatus 2 to a vehicle such as the electric vehicle 3. The electric vehicle 3 is parked in the charging area A. When the electric vehicle 3 and the power feeding apparatus 2 are connected by a power feeding cable, the electric vehicle 3 can be fed with electric power from the power feeding apparatus 2. The charging area A is a partial region of the road surface R. The charging area A may be provided at a plurality of locations on the road surface R. The charging area A may be visually indicated on the road surface R by a frame, a color, or the like. For example, the charging area A may be bordered by a frame having a color different from that of the road surface R close to the charging area A. The charging area A may be painted in a color different from that of the road surface R close to the charging area A. The charging area A need not be visually indicated on the road surface R.

The power feeding apparatus 2 receives supply of electric power from a power source such as a commercial power source or a renewable energy source. Examples of the renewable energy source include, but are not limited to, a solar power generator or a wind power generator. Electric power supplied from the power source or the like is converted into electric power having a voltage, an electric current, and a frequency suitable for power feeding to the electric vehicle 3 via a power conversion circuit including a transformer, a rectifier, a DC-DC converter, an inverter, and the like. Then, the power feeding apparatus 2 supplies AC (alternating current) or DC (direct current) power to the electric vehicle 3. Part or all of the electric power supplied to the electric vehicle 3 is supplied to a battery 6 described later.

The electric vehicle 3 is, for example, a battery electric vehicle (BEV) or a plug-in hybrid electric vehicle (PHEV). The electric vehicle 3 may be a vehicle capable of automated driving. In this case, the electric vehicle 3 may include an automated driving device. The automated driving device recognizes a surrounding environment using information acquired by, for example, a camera, a laser imaging detection and ranging (LiDAR) sensor, or the like. The automated driving device performs automated driving of the electric vehicle 3 by controlling an electric motor (which may include an internal combustion engine in the case of a PHEV) for driving the electric vehicle 3, a steering device, a transmission, a brake, and the like. The automated driving may be automated valet parking that enables traveling near the charging area A at a low speed.

The electric vehicle 3 includes a projection device 4. The projection device 4 projects a predetermined pattern P on a projection surface S that is a surface close to the charging area A. The projection device 4 may be configured integrally with the headlight of the electric vehicle 3. In one example, the projection device 4 may be a liquid crystal projector. In another example, the projection device 4 may modulate light emitted from a light source of a headlight by a spatial light modulator and perform projection using the spatially modulated light.

The projection surface S is, for example, the road surface R close to the charging area A. Being “close to” means that the projected predetermined pattern P and the electric vehicle 3 parked in the charging area A are close to the extent that a driver who has visually observed the projected predetermined pattern P or an automated driving device which has recognized the image can determine that the predetermined pattern P and the electric vehicle 3 parked in the charging area A are associated with each other. The projection surface S may include the charging area A. For example, in a case where the charging area A is wide, the projection surface S may be within the charging area A or may extend between the inside and the outside of the charging area A. The predetermined pattern P only needs to be any image that can be recognized by a person. For example, the predetermined pattern P may be represented by a shape, a design, a color, a character, a combination thereof, or the like. The predetermined pattern P may be constant or may change during projection. The predetermined pattern P may be, for example, a motion picture having a frame rate of 30 frames per second. The predetermined pattern P may change in accordance with the state of charge.

Power feeding of the power feeding apparatus 2 may be of any type. FIGS. 1A and 1B illustrate a power feeding apparatus 2 of a wired power feeding type as an example of the power feeding apparatus 2. The power feeding apparatus 2 includes a power feeding cable for supplying electric power to the electric vehicle 3. In this case, the charging area A may be defined as a range that the power feeding cable can reach. The power feeding apparatus 2 is installed outside the charging area A. The position of the power feeding apparatus 2 may be any position as long as the electric vehicle 3 parked in the charging area A and the power feeding apparatus 2 can be electrically connected to each other and the power feeding apparatus 2 does not interfere with traveling of the electric vehicle 3. The power feeding apparatus 2 may be installed, for example, on a sidewalk provided side by side with the road surface R. When the electric vehicle 3 is parked in the charging area A, the power feeding apparatus 2 is located on the side of the electric vehicle 3.

The power feeding apparatus 2 may communicate with the electric vehicle 3 to control power supply to the electric vehicle 3. The communication between the power feeding apparatus 2 and the electric vehicle 3 may be, for example, wired communication via a power feeding cable or wireless communication. The power feeding cable may be attached and detached by a driver of the electric vehicle 3 or by a robot. In one example, in response to a notification from the electric vehicle 3, the robot may attach and detach the power feeding cable.

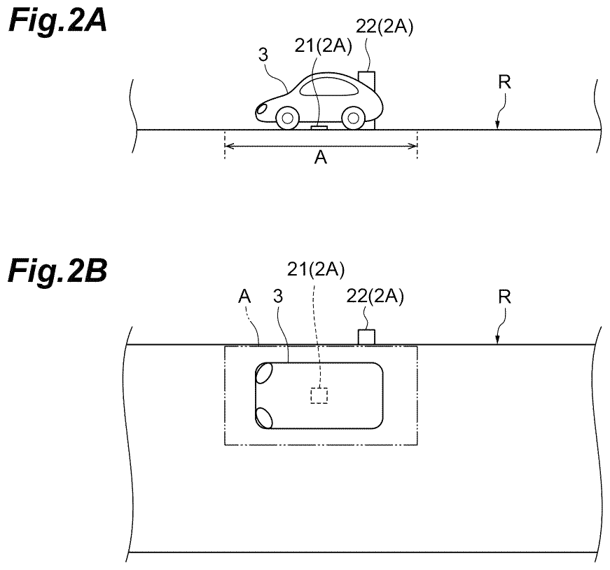

FIGS. 2A and 2B illustrate a power feeding apparatus 2A of a wireless power transfer type as another example of the power feeding apparatus 2. FIG. 2A is a side view schematically illustrating a configuration related to the power feeding apparatus 2A of the wireless power transfer type. FIG. 2B is a plan view schematically illustrating a configuration related to the power feeding apparatus 2A of the wireless power transfer type. The power feeding apparatus 2A generates a magnetic field for power feeding by a power feeding coil. In this case, the charging area A may be a predetermined range surrounding the power feeding coil. When the electric vehicle 3 is parked inside (within) the charging area A, the magnetic field for power feeding reaches the power receiving part of the electric vehicle 3. The battery 6 to be described later receives power feeding from the power feeding apparatus 2A via a power receiving coil that converts the magnetic field into electric power, a rectifier, and a DC-DC converter.

The power feeding apparatus 2A may include a plurality of housings that may be installed separately. The power feeding apparatus 2A may have a first housing 21 and a second housing 22. The first housing 21 may house a power feeding coil, and an inductor and a capacitor constituting a resonance circuit. The second housing 22 may house a power receiving circuit, a DC-DC converter, an inverter, and a power feeding control device. The first housing 21 may be installed inside (within) the charging area A. The second housing 22 may be installed outside the charging area A. The first housing 21 and the second housing 22 may be electrically connected via a cable. In this case, when the electric vehicle 3 is parked in the charging area A, the first housing 21 is located below the electric vehicle 3, and the second housing 22 is located on the side of the electric vehicle 3.

An outline of an advance notice system of the present disclosure will be described with reference to FIGS. 1A and 1B. FIGS. 1A and 1B illustrate an electric vehicle 31 and an electric vehicle 32 as examples of the electric vehicle 3. The electric vehicle 31 is parked in the charging area A to perform charging. The electric vehicle 32 travels on the traveling lane L2 on the road surface R.

The advance notice system detects a preparatory operation performed before the electric vehicle 31 leaves. In response to the detection of the preparatory operation, the projection device 4 projects the predetermined pattern P on the road surface R. The projected predetermined pattern P indicates that the electric vehicle 31 will leave the charging area A shortly. In this manner, the advance notice system 1 gives an advance notice of availability of the charging area A in the charging area A.

In FIG. 1B, a predetermined pattern P is projected ahead in a direction V recognizable from the electric vehicle 32. That is, the driver of the electric vehicle 32 can visually recognize the predetermined pattern P projected on the road surface R. In the case of automated driving, the automated driving device can recognize the predetermined pattern P projected on the road surface R by performing image processing on an image captured by a camera or the like. Therefore, the driver or the like of the electric vehicle 32 can recognize that the charging area A will be available soon even when the electric vehicle 31 is parked in the charging area A. Thereafter, the electric vehicle 31 travels along a route Cl and exits the charging area A. After the electric vehicle 31 leaves the charging area A, the electric vehicle 32 travels along a route C2, and is parked in the charging area A to perform charging.

The projection device 4 may project another pattern indicating attention regarding the movement and direction of the electric vehicle 31 immediately before leaving or after leaving. The another pattern is different from the predetermined pattern P. The another pattern and the predetermined pattern P may be different depending on a shape, a color, a display time (continuous display or blinking display), or a combination thereof.

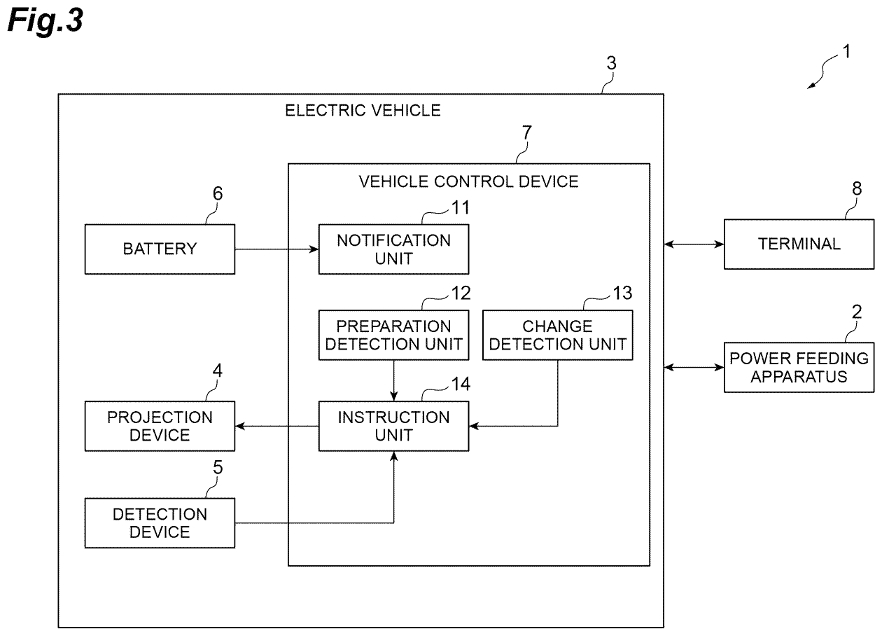

FIG. 3 is a block diagram illustrating an example of the entire configuration including the advance notice system 1. The electric vehicle 3 includes the projection device 4, the detection device 5, a battery 6, and a vehicle control device 7. The advance notice system 1 includes, for example, the projection device 4 and the vehicle control device 7. The electric vehicle 3 may be communicably connected to the power feeding apparatus 2 and a terminal 8. The terminal 8 is, for example, a computer used by a driver of the electric vehicle 3. The terminal 8 is, for example, a smartphone, a tablet terminal, a wearable terminal, or the like, but is not limited thereto.

The detection device 5 acquires an information of a situation around the charging area A. The detection device 5 is, for example, an on-vehicle camera or an on-vehicle radar for an advanced driving assistant system (ADAS). For example, the detection device 5 may capture an image around the electric vehicle 3 by the on-vehicle camera. The detection device 5 may acquire sensing data indicating the presence or absence of an object around the electric vehicle 3 by the on-vehicle radar. In one example, the detection device 5 detects a vehicle around the electric vehicle 3 parked in the charging area A by two-dimensional or three-dimensional image recognition on the basis of an image or sensing data. That is, the detection device 5 detects vehicles around the charging area A. In another example, the detection device 5 may acquire brightness around the electric vehicle 3 parked in the charging area A by performing image processing on the captured image. That is, the detection device 5 acquires brightness around the charging area A. The image processing may be, for example, removal of a portion in which the interior of the electric vehicle 3 and distant scenery are reflected.

The battery 6 supplies traveling energy and power related to various processes of the electric vehicle 3. The battery 6 can be charged by receiving power feeding from the power feeding apparatus 2. In the case of fast charging, the battery 6 receives feeding of DC power directly from the power feeding apparatus 2. In the case of normal charging, the battery 6 receives feeding of AC power via a rectifier and a DC-DC converter.

The vehicle control device 7 is an electronic control unit (ECU) that controls the electric vehicle 3. The vehicle control device 7 includes, for example, a central processing unit (CPU), a read only memory (ROM), a random access memory (RAM), an input/output circuit, a communication device, and the like. In the vehicle control device 7, for example, a program stored in the ROM is loaded into the RAM, and the program loaded into the RAM is executed by the CPU to implement various functions.

The vehicle control device 7 performs charge control of the battery 6, monitoring of a state of charge (SOC) of the battery 6, transmission and reception of a signal to and from the power feeding apparatus 2, instruction to the projection device 4, and the like. The vehicle control device 7 includes a notification unit 11, a preparation detection unit 12, a change detection unit 13, and an instruction unit 14 as functional elements.

The notification unit 11 monitors the state of charge of the battery 6, and notifies the terminal 8 of the state in a case where the battery 6 is in a predetermined state of charge. For example, the notification unit 11 determines whether or not charging has ended, and transmits a message indicating that charging has ended to the terminal 8 when the charging has ended. In one example, when the SOC becomes equal to or more than 80%, the notification unit 11 may determine that the charging has ended. In another example, when an electricity bill required for charging exceeds a threshold value corresponding to the electricity bill, the notification unit 11 may determine that the charging has ended. In still another example, when the driver of the electric vehicle 3 interrupts charging instructing from the terminal 8, the notification unit 11 may determine that the charging has ended.

The preparation detection unit 12 detects a preparatory operation that is an operation performed before the vehicle such as the electric vehicle 3 leaves the charging area A. Examples of the preparatory operation include a remote operation using one or more of keyless entry, a smart key, and the terminal 8. An on-vehicle device of the electric vehicle 3 can be activated by remote control. Examples of the on-vehicle device include, but are not limited to, one or a plurality of devices such as an air conditioner, a defroster, a vehicle interior light, a vehicle interior sound device, and an entertainment device. The preparatory operation may be a departure instruction of automated driving. The departure instruction of automated driving is, for example, an instruction to start generation of an automated driving map or the like. When the preparatory operation is detected, it can be said that the time at which the electric vehicle 3 leaves the charging area A is close.

The change detection unit 13 detects a change in state immediately before the vehicle such as the electric vehicle 3 leaves the charging area A. Examples of the change include, but are not limited to, switching of a lever of a transmission from parking to driving, depression of an accelerator pedal, application of a voltage from the battery 6 to a DC bus of an inverter that drives an electric motor for traveling, and the like. When the change is detected, it can be said that it is immediately before the electric vehicle 3 leaves the charging area A.

In response to detection of the preparatory operation, the instruction unit 14 gives a start instruction to the projection device 4, the start instruction being an instruction to start projection of the predetermined pattern P. The projection device 4 starts projection of the predetermined pattern P in response to the start instruction from the vehicle control device 7.

The instruction unit 14 gives a stop instruction to the projection device 4 in response to detection of the change, the stop instruction being an instruction to stop the projection of the predetermined pattern P. The projection device 4 stops the projection of the predetermined pattern P in response to the stop instruction from the vehicle control device 7.

The instruction unit 14 may adjust the brightness of the projection of the predetermined pattern P. For example, the instruction unit 14 may give an adjustment instruction to the projection device 4, the adjustment instruction being an instruction to adjust luminance of the predetermined pattern P on the basis of brightness of the image acquired by the detection device 5. In one example, the brightness of the image acquired by the detection device 5 is brightness around the electric vehicle 3 parked in the charging area A. When the periphery of the charging area A is bright (for example, equal to or more than a predetermined brightness), the instruction unit 14 may give an adjustment instruction in which the luminance of the predetermined pattern P is set high (for example, equal to or more than a predetermined luminance value) to the projection device 4. In this case, visibility of the predetermined pattern P can be improved. In another example, when the periphery of the charging area A is dark (for example, less than a predetermined brightness), an adjustment instruction in which the luminance of the predetermined pattern P is set low (for example, less than a predetermined luminance value) may be given to the projection device 4. In this case, the power consumption for projecting the predetermined pattern P can be suppressed.

A method of defining the predetermined pattern P is not limited. For example, the electric vehicle 3 may store bitmap data of the predetermined pattern P in advance in a memory of the projection device 4 or the vehicle control device 7. The power feeding apparatus 2 may transmit the bitmap data of the predetermined pattern P to the electric vehicle 3 via communication for power feeding control. The predetermined pattern P may be displayed on an outer surface of the power feeding apparatus 2. In this case, the detection device 5 may capture the predetermined pattern P displayed on the outer surface of the power feeding apparatus 2 by the on-vehicle camera. The instruction unit 14 may cut out only a portion of the predetermined pattern P in the image captured by the detection device 5 to acquire the bitmap data of the predetermined pattern P. The instruction unit 14 may transmit the bitmap data to the projection device 4 at the same time as or before giving the start instruction to the projection device 4.

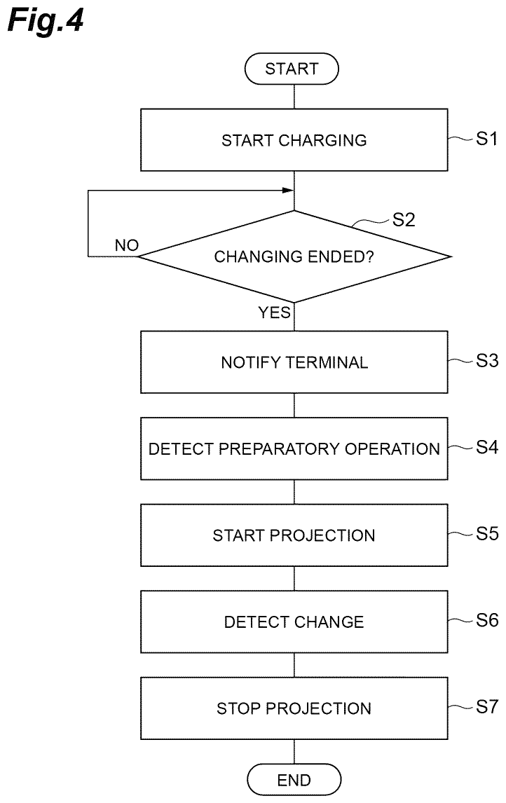

An example of an operation method (advance notice method) of the advance notice system 1 will be described with reference to FIG. 4. FIG. 4 is a flowchart illustrating an example of the operation of the advance notice system 1.

In step S1, the electric vehicle 3 is parked in the charging area A and starts charging. For example, when the power feeding apparatus 2 is a wired power feeding type, the power feeding cable is connected to the electric vehicle 3. Then, the electric vehicle 3 is fed with power from the power feeding apparatus 2 via the power feeding cable.

In step S2, the notification unit 11 determines whether or not charging has ended. For example, the notification unit 11 may monitor the state of charge of the battery 6 and determine whether or not the charging has ended on the basis of whether or not the SOC is equal to or more than 80%. The notification unit 11 may determine whether or not the charging has ended on the basis of whether or not the electricity bill required for charging exceeds a threshold value corresponding to the electricity bill. The notification unit 11 may determine whether or not the charging has ended on the basis of whether or not the charging time exceeds a threshold value corresponding to the charging time. The notification unit 11 may determine whether or not the charging has ended on the basis of whether or not charging has been interrupted. When the charging has ended (YES in step S2), the processing proceeds to step S3. When the charging has not ended (NO in step S2), the processing of step S2 is repeated.

In step S3, the notification unit 11 transmits a message indicating that the charging has ended to the terminal 8. The terminal 8 displays the received message on the display device. The terminal 8 may make it easy for the holder of the terminal 8 to notice the message by blinking of the screen, generation of a sound, reading of a message, vibration of a vibrator, or the like.

In step S4, the preparation detection unit 12 detects the preparatory operation. For example, the preparation detection unit 12 may detect activation of an on-vehicle device of the electric vehicle 3 by remote control as the preparatory operation. The preparation detection unit 12 may detect a departure instruction of automated driving as a preparatory operation.

In step S5, in response to the detection of the preparatory operation, the instruction unit 14 gives a start instruction to the projection device 4 to start projection of the predetermined pattern P. The projection device 4 starts projection of the predetermined pattern P in response to the start instruction from the vehicle control device 7.

In step S6, the change detection unit 13 detects a change in state immediately before leaving the charging area A. In one example, the change detection unit 13 may detect a change in the lever of the transmission from parking to driving as a change. In another example, the change detection unit 13 may detect depression of the accelerator pedal as a change. In still another example, the change detection unit 13 may detect, as a change, application of a voltage from the battery 6 to the DC bus of the inverter that drives the electric motor for traveling.

When the power feeding apparatus 2 is a wired power feeding type, the power feeding cable is disconnected before the electric vehicle 3 leaves the charging area A. For example, before step S6, the driver of the electric vehicle 3 disconnects the power feeding cable and gets on the electric vehicle 3. When the electric vehicle 3 is driven in an automated manner, an instruction to release the connection of the power feeding cable may be given from the electric vehicle 3 to the robot disposed around the charging area A before step S6.

In step S7, in response to the detection of the change, the instruction unit 14 gives a stop instruction to the projection device 4 to stop the projection of the predetermined pattern P. The projection device 4 stops the projection of the predetermined pattern P in response to the stop instruction from the vehicle control device 7. Thereafter, the electric vehicle 3 leaves the charging area A.

In FIG. 4, the processing of step S4 may be performed before step S2 or S3. That is, the preparation detection unit 12 may detect the preparatory operation before the end of charging. In this case, in response to the detection of the preparatory operation, the vehicle control device 7 may instruct the power feeding apparatus 2 to stop the power feeding. The processing of step S7 may be performed after the electric vehicle 3 leaves the charging area A. The processing of step S3 need not be performed. For example, the notification unit 11 may determine that charging has ended when the driver of the electric vehicle 3 interrupts charging or the like, and does not need to notify the terminal 8.

As described above, the advance notice system 1 according to one aspect of the present disclosure gives an advance notice of availability of the charging area A in the charging area A where power feeding is performed from the power feeding apparatus 2 to a vehicle such as the electric vehicle 3. The advance notice system 1 includes the projection device 4 configured to project the predetermined pattern P on the projection surface S that is a surface close to the charging area A in response to an instruction, and the vehicle control device 7 including the preparation detection unit 12 configured to detect a preparatory operation that is an operation performed before a vehicle such as the electric vehicle 3 leaves the charging area A, and the instruction unit 14 that configured to give a start instruction to the projection device 4 in response to detection of the preparatory operation, the start instruction being an instruction to start projection of the predetermined pattern P.

In the advance notice system 1 of the present disclosure, projection of the predetermined pattern P on the projection surface S is started in response to detection of the preparatory operation performed before a vehicle such as the electric vehicle 3 leaves the charging area A. In other words, by projecting the predetermined pattern P on the projection surface S, an advance notice of availability of the charging area A is given. For example, when seen from another electric vehicle passing around the charging area A, the predetermined pattern P can be recognized. A driver or the like of another electric vehicle can recognize that the charging area A will be available soon by recognizing the predetermined pattern P. Therefore, the driver or the like of another electric vehicle only needs to wait until the charging area A becomes available, and does not need to look for another charging area. That is, another electric vehicle can immediately start charging using the power feeding apparatus 2. As a result, the occupancy rate of the charging area A is improved, and convenience for drivers or the like of other electric vehicles using the charging area A is improved. In the example illustrated in FIGS. 1A and 1B, the electric vehicle 31 includes the advance notice system 1, and the electric vehicle 32 may correspond to another electric vehicle.

Further, in the advance notice system 1 of the present disclosure, it is not necessary to perform wireless communication with another electric vehicle. Here, wireless communication may be difficult depending on the situation of the another electric vehicle. For example, when a metal wall is installed near the another electric vehicle, it may be difficult to attain radio wave strength for wireless communication. In another example, other electric vehicles may not be able to establish a wireless communication connection due to a failure in password authentication or the like used for wireless communication. On the other hand, in the advance notice system 1, the predetermined pattern P that can be recognized by visual confirmation, image processing, or both is projected. Thus, the advance notice system 1 can give an advance notice of the available charging area A regardless of the situation of wireless communication. In addition, by using the projection device 4, it is possible to improve the visibility of the predetermined pattern P as compared with, for example, display on a liquid crystal display. In one example, the projection device 4 can indicate the enlarged predetermined pattern P. In another example, the projection device 4 can project the predetermined pattern P at a position away from the vehicle body.

In the case of the power feeding apparatus 2 of the wired power feeding type, since the power feeding cable is connected to the electric vehicle 3, it is difficult to determine when the power feeding ends. In the advance notice system 1, even when the power feeding cable is connected to the electric vehicle 3, an advance notice of availability of the charging area A is given in response to the detection of the preparatory operation. In the case of the power feeding apparatus 2A of the wireless power transfer type, it is difficult to determine whether power is being fed from the appearance of the power feeding apparatus 2A. In the advance notice system 1, an advance notice of availability of the charging area A is given in response to the detection of the preparatory operation.

The advance notice system 1 includes the change detection unit 13 configured to detect a change in a state immediately before a vehicle such as the electric vehicle 3 leaves the charging area A. The instruction unit 14 gives a stop instruction to the projection device 4 in response to detection of the change, the stop instruction being an instruction to stop the projection of the predetermined pattern P. In this case, the projection of the predetermined pattern P is stopped immediately before the vehicle such as the electric vehicle 3 leaves the charging area A. Accordingly, power consumption for projection can be suppressed. In addition, when the projection of the predetermined pattern P is stopped, the projection device 4 can be brought into a state capable of projecting another pattern. For example, the projection device 4 can be used for projecting a pattern indicating an advance notice of a moving direction or the like.

The advance notice system 1 includes the detection device 5 configured to detect a vehicle around the charging area A. The instruction unit 14 gives the start instruction to the projection device 4 further on the basis of detection of the vehicle. For example, when a vehicle is detected around the charging area A, projection of the predetermined pattern P is started. When the vehicle is not detected around the charging area A, projection of the predetermined pattern P is not started. Accordingly, power consumption for projection can be suppressed.

The advance notice system 1 includes the detection device 5 configured to capture an image around the charging area A. The instruction unit 14 gives an adjustment instruction to the projection device 4, the adjustment instruction being an instruction to adjust the luminance of the predetermined pattern P on the basis of the brightness of the image acquired by the detection device 5. By increasing the luminance value of the predetermined pattern P, the visibility of the predetermined pattern P can be improved. By decreasing the luminance value of the predetermined pattern P, the power consumption for projection can be suppressed.

The electric vehicle 3 according to one aspect of the present disclosure includes the above-described advance notice system 1. By the electric vehicle 3, the occupancy rate of the charging area A is improved, and the convenience for drivers or the like of other electric vehicles using the charging area A is improved.

### Modifications

The present disclosure is not limited to the above-described embodiments, and various alterations can be made without departing from the gist of the present disclosure.

The predetermined pattern P may be represented by a different pattern corresponding to the connection state of the power feeding cable. For example, when the power feeding apparatus 2 and the electric vehicle 3 are connected by the power feeding cable, the predetermined pattern P may be represented by a first pattern. When the power feeding cable between the power feeding apparatus 2 and the electric vehicle 3 is removed, the predetermined pattern P may be represented by a second pattern different from the first pattern. In one example, the first pattern and the second pattern may differ by shape, color, display time (continuous display or blinking display), or a combination thereof.

The power feeding apparatus 2 may restart power feeding while the projection device 4 projects the predetermined pattern P even when the power feeding has ended. For example, when the instruction unit 14 instructs the projection device 4 to project the predetermined pattern P, the vehicle control device 7 may perform communication for requesting power feeding with the power feeding apparatus 2. In this case, the amount of power consumed by the activated on-vehicle devices and the projection device 4 can be complemented to suppress a decrease in the amount of charge of the battery 6.

The terminal 8 may receive an input of whether or not to project the predetermined pattern P. The terminal 8 transmits the input of whether or not to project to the vehicle control device 7. The instruction unit 14 may set whether or not to perform the start instruction on the basis of the input of whether or not to project. For example, the driver of the electric vehicle 3 parks the electric vehicle 3 in one of the plurality of charging areas A provided. When the driver determines that there is a plurality of available charging areas A, the driver may input to the terminal 8 not to project the predetermined pattern P. In this case, the power consumption for projecting the predetermined pattern P can be suppressed.

The power feeding apparatus 2 may identify the electric vehicle 3 on which the projection device 4 or the like of the present disclosure is mounted. For example, the power feeding apparatus 2 may acquire an identification code of the electric vehicle 3 in advance and store the identification code as a part of a procedure of transmitting and receiving a control signal to and from the electric vehicle 3. The identification code is a number unique to each electric vehicle 3, and is, for example, a vehicle registration number. For example, the power feeding apparatus 2 may acquire the identification code from the electric vehicle 31 when starting power feeding of the electric vehicle 31. The power feeding apparatus 2 may check the acquired identification code against the identification code stored in advance. Then, the power feeding apparatus 2 may determine whether or not the charging of the electric vehicle 32 is started within a certain period of time after the charging of the electric vehicle 31 is finished. In other words, the power feeding apparatus 2 may determine whether or not charging is started by another electric vehicle 3 immediately after the charging area A becomes available. When charging of the electric vehicle 32 is started within a certain period of time, the power feeding apparatus 2 may give an incentive to the electric vehicle 31. The incentive may be, for example, a reduction in the electricity bill required for the next charge.

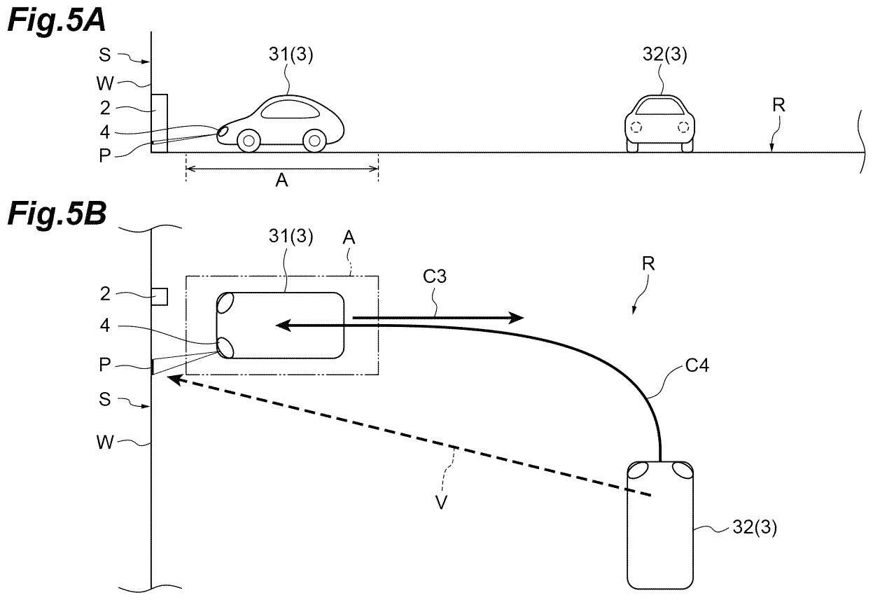

In the above embodiment, the example in which the projection surface S is the road surface R has been described, but the present disclosure is not limited thereto. FIG. 5A is a side view schematically illustrating projection surface S according to a modification. FIG. 5B is a plan view schematically illustrating projection surface S according to the modification. The charging area A may be provided on the road surface R at a dead end. A wall surface W is provided at the dead end. The power feeding apparatus 2 may be installed on the wall surface W. The electric vehicle 31 may be parked in the charging area A so that the front surface of the vehicle body faces the wall surface W. The projection device 4 may project the predetermined pattern P on the wall surface W. That is, the projection surface S may be the wall surface W. The projection device 4 may project the predetermined pattern P across the wall surface W and the road surface R. That is, the projection surface S may be the wall surface W and the road surface R. When at least a part of the projection surface S is the wall surface W, it is possible to reduce the distance between the charging area A for projecting the predetermined pattern P and the wall surface W.

The electric vehicle 32 approaches the charging area A from the side opposite to the wall surface W. In FIG. 5B, a predetermined pattern P is projected ahead in a direction V recognizable from the electric vehicle 32. That is, the driver or the like of the electric vehicle 32 can recognize the predetermined pattern P projected on the wall surface W. Therefore, the driver or the like of the electric vehicle 32 can recognize that the charging area A will be available soon even when the electric vehicle 31 is parked in the charging area A. Thereafter, the electric vehicle 31 travels along a route C3 and exits the charging area A. After the electric vehicle 31 leaves the charging area A, the electric vehicle 32 travels along a route C4, and is parked in the charging area A to perform charging.

The road surface R may be provided across a plurality of floors as in, for example, a multi-layer parking lot attached to a commercial facility or the like. The charging area A may be provided on each floor. The projection device 4 may project the predetermined pattern P using the road surface R or the wall surface W of each floor as the projection surface S. Since the projected light is blocked by the road surface R of each floor, the predetermined patterns P of the electric vehicles 3 parked in a vertical direction do not overlap each other, and the predetermined pattern P can be visually recognized on each floor.

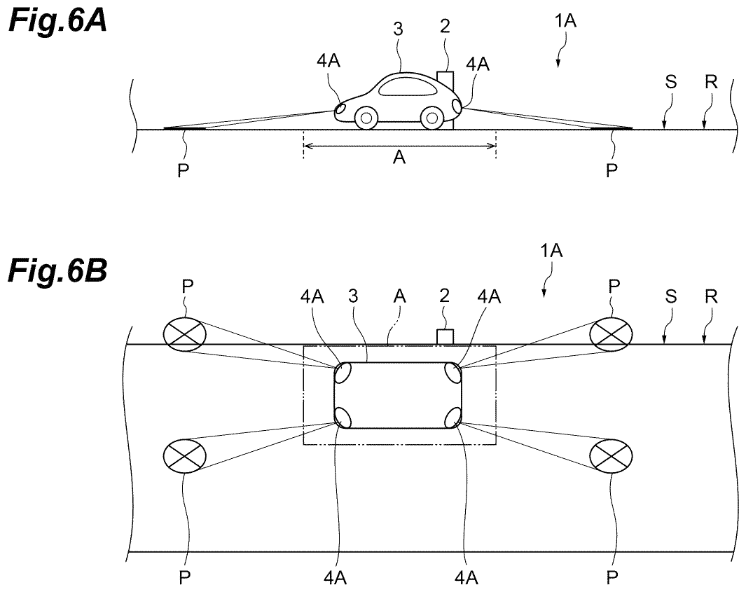

In the above embodiment, the example in which the predetermined pattern P is projected at one location of the projection surface S has been described, but the present disclosure is not limited thereto. FIG. 6A is a side view schematically illustrating a configuration related to an advance notice system 1A according to the modification. FIG. 6B is a plan view schematically illustrating the configuration related to the advance notice system 1A according to the modification. The advance notice system 1A is different from the advance notice system 1 in that the advance notice system 1A includes a plurality of projection devices 4A instead of the projection device 4.

Each of the plurality of projection devices 4A may have a configuration similar to that of the projection device 4. The plurality of projection devices 4A projects the predetermined pattern P at a plurality of locations around the electric vehicle 3. For example, the plurality of projection devices 4A may project the predetermined pattern P on the road surface R on a left front side, a right front side, a left rear side, and a right rear side of the electric vehicle 3. The predetermined pattern P may be projected on a sidewalk, a wall surface W, or the like. In the advance notice system 1A, since the predetermined pattern P is projected at the plurality of locations around the electric vehicle 3 parked in the charging area A, visibility from other electric vehicles is improved even if the relative positions of the other electric vehicles are changed with respect to the electric vehicle 3 parked in the charging area A.

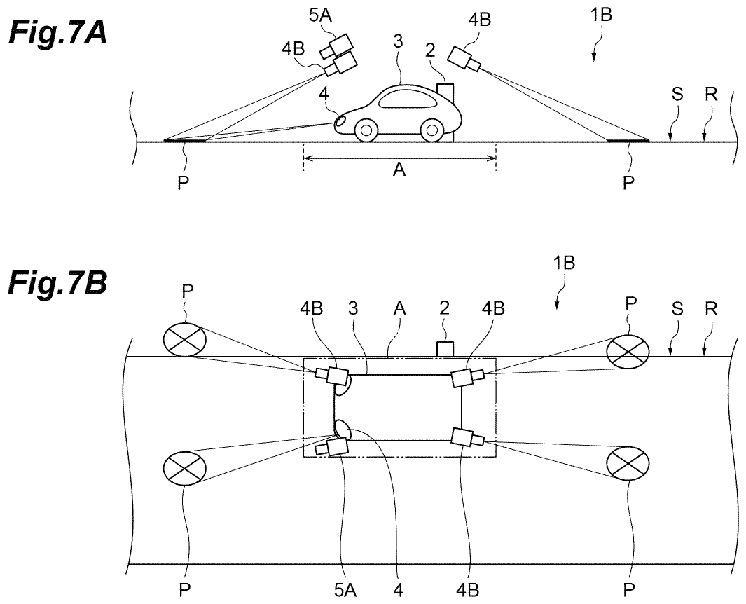

In the above embodiment, the example in which the predetermined pattern P is projected at one location of the projection surface S has been described, but the present disclosure is not limited thereto. FIG. 7A is a side view schematically illustrating a configuration related to an advance notice system 1B according to another modification. FIG. 7B is a plan view schematically illustrating the configuration related to the advance notice system 1B according to another modification. The advance notice system 1B is different from the advance notice system 1 in further including a detection device 5A installed on the ground side and a projection device 4B installed on the ground side. The “installed on the ground side” means that it is not mounted on the electric vehicle 3, and the relative position with respect to the charging area A is fixed.

The detection device 5A captures the predetermined pattern P projected on the projection surface S. The detection device 5A is, for example, a camera installed on a pole standing on the ground. The detection device 5A is installed near the charging area A at a position that does not hinder parking of the electric vehicle 3 and projection of the predetermined pattern P. The detection device 5A is installed, for example, above the charging area A and at a position higher than a vehicle height of the electric vehicle 3 parked in the charging area A. The detection device 5A transmits data (for example, bitmap data) defining the predetermined pattern P obtained by performing image processing on the captured image to the projection device 4B. The image processing may be, for example, segmentation of a region, binarization, affine transformation for correcting image distortion, and the like.

The projection device 4B further projects the predetermined pattern P on another position of the projection surface S by using the predetermined pattern P captured by the detection device 5A. The projection device 4B is installed near the charging area A at a position that does not hinder parking of the electric vehicle 3 and projection of the predetermined pattern P. The projection device 4B is installed, for example, above the charging area A and at a position higher than the vehicle height of the electric vehicle 3 parked in the charging area A. The number of projection devices 4B is not limited, and may be three, for example.

The projection device 4 may project the predetermined pattern P on the road surface R on the left front side of the electric vehicle 3. The detection device 5A captures the predetermined pattern P projected on the road surface R. The projection device 4B further projects the predetermined pattern P on another position of the projection surface S by using the predetermined pattern P captured by the detection device 5A. For example, the projection device 4B may project the predetermined pattern P on the right front side, the left rear side, and the right rear side of the electric vehicle 3.

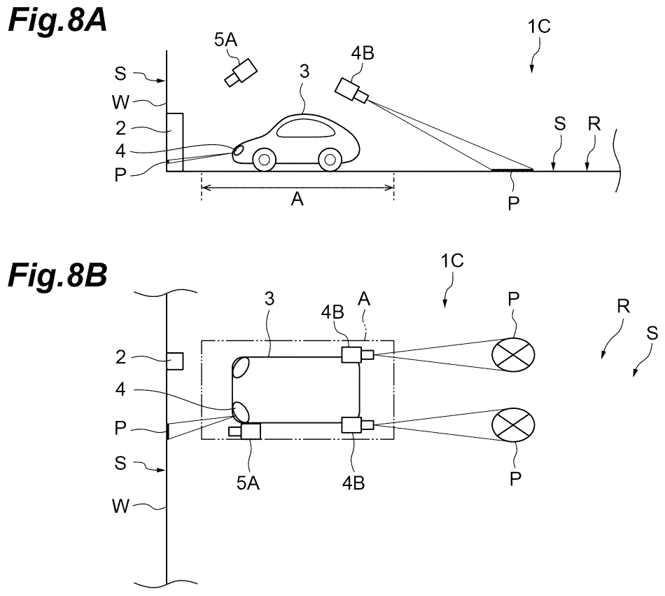

FIG. 8A is a side view schematically illustrating a configuration related to an advance notice system 1C according to still another modification. FIG. 8B is a plan view schematically illustrating the configuration related to the advance notice system 1C according to still another modification. The advance notice system 1C is different from the advance notice system 1B in that a part of the projection surface S is the wall surface W, and the number of projection devices 4B installed on the ground side is two.

The electric vehicle 3 may be parked in the charging area A so that the front surface of the vehicle body faces the wall surface W. The projection device 4 may project the predetermined pattern P on the wall surface W on the left front side of the electric vehicle 3. The detection device 5A captures the predetermined pattern P projected on the projection surface S. The projection device 4B further projects the predetermined pattern P on another position of the projection surface S by using the predetermined pattern P captured by the detection device 5A. For example, the projection device 4B may project the predetermined pattern P on the left rear side and the right rear side of the electric vehicle 3.

As described above, each of the advance notice systems 1B and 1C includes the detection device 5A installed on the ground side and configured to capture the predetermined pattern P projected on the projection surface S, and the projection device 4B installed on the ground side and configured to further project the predetermined pattern P on another position of the projection surface S by using the predetermined pattern P captured by the detection device 5A installed on the ground side.

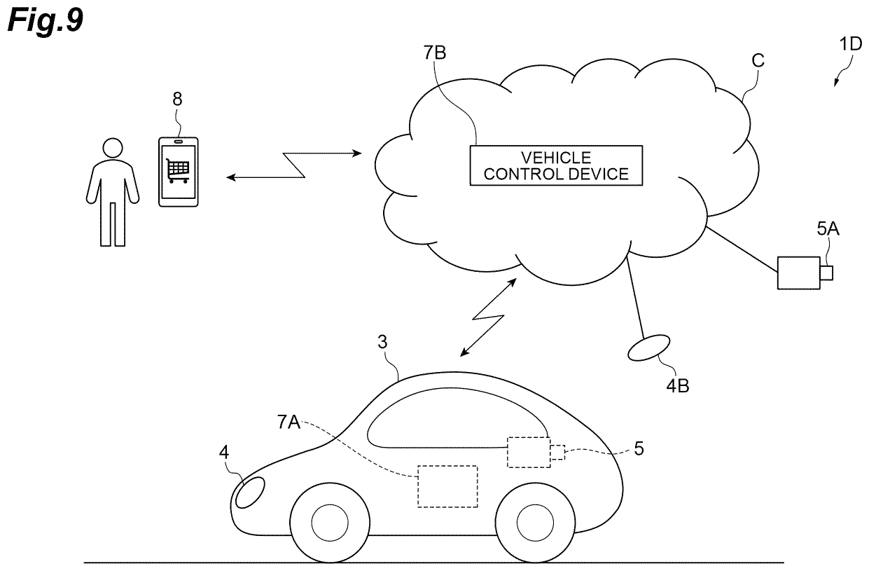

In the above embodiment, an example in which the vehicle control device 7 and the projection device 4 are mounted on the electric vehicle 3 has been described, but the present disclosure is not limited thereto. FIG. 9 is a diagram schematically illustrating a configuration related to an advance notice system 1D according to yet another modification. The advance notice system 1D is different from the advance notice system 1 in that an installation location of each device is not limited.

In the advance notice system 1D, the electric vehicle 3 includes a vehicle control device 7A, and a cloud C includes a vehicle control device 7B. The cloud C is a combination of arbitrary computers that can be interconnected and used through a network. The cloud C is communicably connected to the electric vehicle 3, the terminal 8, the projection device 4B installed on the ground side, and the detection device 5A installed on the ground side.

The vehicle control device 7A and the vehicle control device 7B cooperate to implement the function of the vehicle control device 7. For example, the vehicle control device 7B has some or all of the functions of the vehicle control device 7. The instruction unit 14 of the vehicle control device 7A may give a start instruction and a stop instruction to the projection device 4 mounted on the electric vehicle 3. The instruction unit 14 of the vehicle control device 7B may give a start instruction and a stop instruction to the projection device 4B capable of communicating with the cloud C. The projection device 4B starts projection of the predetermined pattern P in response to the start instruction from the vehicle control device 7B. The projection device 4B stops projection of the predetermined pattern P in response to the stop instruction from the vehicle control device 7B.

The gist of the present disclosure will be indicated below.

[1]

An advance notice system for giving, in a charging area where power feeding is performed from a power feeding apparatus to a vehicle, an advance notice of availability of the charging area, the advance notice system including:
a projection device configured to project a predetermined pattern on a projection surface that is a surface close to the charging area in response to an instruction; and
a vehicle control device including a preparation detection unit configured to detect a preparatory operation that is an operation performed before a vehicle leaves the charging area, and an instruction unit configured to give a start instruction to the projection device in response to detection of the preparatory operation, the start instruction being an instruction to start projection of the predetermined pattern.
   [2]

The advance notice system according to [1], further including:
a change detection unit configured to detect a change in a state immediately before a vehicle leaves the charging area, in which
the instruction unit gives a stop instruction to the projection device in response to detection of the change, the stop instruction being an instruction to stop the projection of the predetermined pattern.
   [3]

The advance notice system according to [1] or [2], further including:
a detection device configured to detect a vehicle around the charging area, in which
the instruction unit gives the start instruction to the projection device further on a basis of detection of the vehicle.
   [4]

The advance notice system according to any one of [1] to [3], further including:
a detection device configured to capture an image around the charging area, in which
the instruction unit gives an adjustment instruction to the projection device, the adjustment instruction being an instruction to adjust luminance of the predetermined pattern on a basis of brightness of an image acquired by the detection device.
   [5]

The advance notice system according to any one of [1] to [4], further including:
a detection device installed on a ground side and configured to capture the predetermined pattern projected on the projection surface; and
a projection device installed on the ground side and configured to further project the predetermined pattern on another position of the projection surface by using the predetermined pattern captured by the detection device installed on the ground side.
   [6]

An electric vehicle including the advance notice system according to any one of [1] to [4].

What is claimed is:

1. An advance notice system for giving, in a charging area where power feeding is performed from a power feeding apparatus to a vehicle, an advance notice of availability of the charging area, the advance notice system comprising:
a projection device configured to project a predetermined pattern on a projection surface that is a surface close to the charging area in response to an instruction; and
a vehicle control device including a preparation detection unit configured to detect a preparatory operation that is an operation performed before a vehicle leaves the charging area, and an instruction unit configured to give a start instruction to the projection device in response to detection of the preparatory operation, the start instruction being an instruction to start projection of the predetermined pattern.

2. The advance notice system according to claim 1, further comprising:
a change detection unit configured to detect a change in a state immediately before a vehicle leaves the charging area, wherein
the instruction unit gives a stop instruction to the projection device in response to detection of the change, the stop instruction being an instruction to stop the projection of the predetermined pattern.

3. The advance notice system according to claim 1, further comprising:
a detection device configured to detect a vehicle around the charging area, wherein
the instruction unit gives the start instruction to the projection device further on a basis of detection of the vehicle.

4. The advance notice system according to claim 1, further comprising:
a detection device configured to capture an image around the charging area, wherein
the instruction unit gives an adjustment instruction to the projection device, the adjustment instruction being an instruction to adjust luminance of the predetermined pattern on a basis of brightness of an image acquired by the detection device.

5. The advance notice system according to claim 1, further comprising:
a detection device installed on a ground side and configured to capture the predetermined pattern projected on the projection surface; and
a projection device installed on the ground side and configured to further project the predetermined pattern on another position of the projection surface by using the predetermined pattern captured by the detection device installed on the ground side.

6. An electric vehicle comprising the advance notice system according to claim 1.
